(19) United States
(12) Patent Application Publication
(10) Pub. No.: US 2012/0268789 A1
(43) Pub. Date: Oct. 25, 2012

(54) IMAGE FORMING APPARATUS AND METHOD FOR CONTROLLING IMAGE FORMING APPARATUS

(75) Inventor: Ryohei Yamada, Kawasaki-shi (JP)

(73) Assignee: CANON KABUSHIKI KAISHA, Tokyo (JP)

(21) Appl. No.: 13/449,028

(22) Filed: Apr. 17, 2012

(30) Foreign Application Priority Data
Apr. 21, 2011 (JP) 2011-095348

(51) Int. Cl. G06K 15/02

(52) U.S. Cl. 358/1.16

(57) ABSTRACT

An image forming apparatus specifies a factor why a decrease of a data transfer rate to the storing unit occurs in consideration of a vibration source that vibrates along with image forming processing of an image forming apparatus, and notifies the factor to a user. A control method for controlling an image forming apparatus that performs image forming processing by driving a driving member includes storing data in a storing unit, measuring a transfer rate in transferring predetermined data to the storing unit while driving the driving member, specifying a transfer rate in transferring the predetermined data to the storing unit while suspending an operation of the driving member, and notifying a factor why a decrease of the data transfer rate to the storing unit occurs according to the measured transfer rate and the specified transfer rate.

### BACKGROUND OF THE INVENTION

1. Field of the Invention

The present invention relates to an image forming apparatus and a method for controlling the image forming apparatus.

2. Description of the Related Art

There have been conventional image forming apparatuses including amass storage device such as a hard disk drive (HDD) that are capable of storing job data in the HDD. In such an image forming apparatus, decrease of a data transfer rate to the HDD sometimes occurs. It is known that such a decrease of the data transfer rate occurs due to, for example, a malfunction or deterioration of the HDD, and due to vibration generated during an operation of the image forming apparatus, e.g., vibration generated by a motor for rotatably driving a drum.

However, in the conventional image forming apparatus, in a case where the decrease of the data transfer rate to the HDD occurs, it is not possible to specify the factor why the decrease occurs. To solve the above problem, Japanese Patent Laid-Open No. 2007-018602 discusses a technique in which the image forming apparatus measures the data transfer rate to the HDD and compares it with a predetermined threshold, and then a notification of an abnormality of a storage device is notified according to the comparison result.

In the conventional technique, however, a size of image data to be actually transferred and a physical address to be accessed thereof cannot be specified. In other words, a data transfer rate of the storage device cannot be measured under a measurement condition similar to a condition that the image forming apparatus is in operation. Therefore, it is sometimes difficult to specify whether a delay of the data transfer rate occurs due to the malfunction of the HDD itself.

That is, a vibration source other than the HDD itself, e.g., a vibration source at which vibration of a motor driving during the image forming processing of the image forming apparatus is generated, is not considered. Therefore, there may be a case that a user may erroneously recognize that the malfunction of the HDD is occurring, although a status of the HDD itself is normal, i.e., although a delay of the data transfer rate occurs due to the vibration generated in the image forming apparatus. Further, the user may replace the HDD based on the user's erroneous recognition.

### SUMMARY OF THE INVENTION

According to an aspect of the present invention, an image forming apparatus for performing image forming processing by driving a driving member includes a storing unit configured to store data, a measuring unit configured to measure the number of retry times occurring during transfer of predetermined data to the storing unit while driving the driving member, a specifying unit configured to specify the number of retry times occurring during the transfer of the predetermine data to the storing unit while suspending an operation of the driving member, and a notification unit configured to notify a factor why a decrease of a data transfer rate with respect to the storing unit occurs according to the number of retry times measured by the measuring unit and the number of retry times specified by the specifying unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a control configuration of an image forming apparatus.

FIG. 2 is a flow chart illustrating a method for controlling the image forming apparatus.

FIG. 3 is a block diagram illustrating a configuration of a motor control unit for driving the image forming apparatus.

FIG. 4 is a memory map illustrating an example of an address allotted to a HDD.

FIG. 5 is a flow chart illustrating a method for controlling the image forming apparatus.

### DESCRIPTION OF THE EMBODIMENTS

Various exemplary embodiments, features, and aspects of the invention will be described in detail below with reference to the drawings.

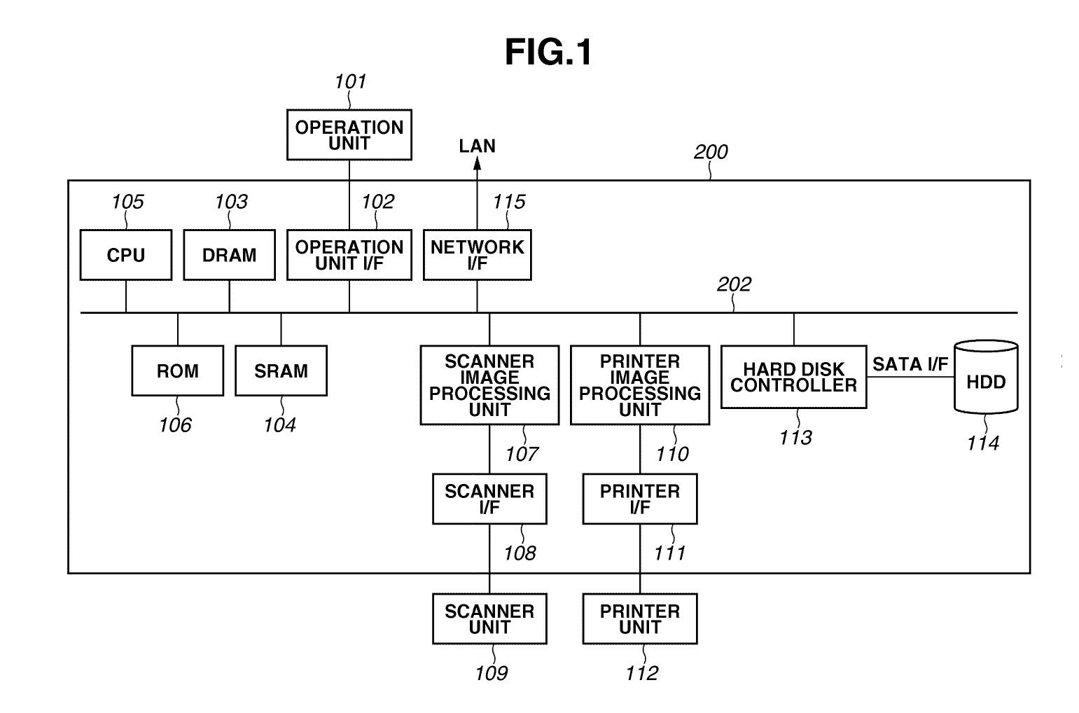

FIG. 1 is a block diagram illustrating a system control configuration of a digital multifunction peripheral as an example of an image forming apparatus according to an exemplary embodiment. In the digital multifunction peripheral according to the present exemplary embodiment, a scanner unit, a printer unit, and a post-processing unit optionally connected to the digital multifunction peripheral according to the present exemplary embodiment also include a plurality of vibration sources. Examples of the vibration source include a plurality of driving members (i.e., motors) for driving a rotation drive system, a sheet conveyance system, and a fixing system which are driven in each process essential to image formation performed by the image forming apparatus.

In FIG. 1, a system controller 200 has a controller function for controlling a multi function peripheral (MFP). The system controller 200 is electrically connected to an operation unit 101, a scanner unit 109, and a printer unit 112 and is capable of communicating with personal computers, external devices, and the like via a Local Area Network (LAN) to exchange image data and device information therebetween.

A central processing unit (CPU) 105 collectively controls the devices connected to a system bus 202 based on a boot program for the image forming apparatus stored in a read only memory (ROM) 106. A dynamic random access memory (DRAM) 103 is a system work memory for the CPU 105. In the DRAM 103, contents stored therein are deleted when the power is turned off.

A static random access memory (SRAM) 104 is a nonvolatile memory. In the SRAM 104, contents stored therein are backed up with a battery so as to be maintained after the power is turned off. A hard disk controller 113 performs information storage such as write and read of image data into/from the HDD 114 that functions as a disk drive apparatus. The hard disk controller 113 is connected to the HDD 114 via a Serial Advanced Technology Attachment Inter Face (SATA I/F).

An operation unit I/F 102 is an interface for connecting the system bus 202 with the operation unit 101. The operation unit I/F 102 receives image data to be displayed on an operation unit 101 via the system bus 202 to output the image data to the operation unit 101, and outputs information input from the operation unit 101 to the system bus 202.

A network I/F 115 is connected to the LAN and the system bus 202. The digital multifunction peripheral communicates with external devices via the LAN and notifies a status of the digital multifunction peripheral to the external devices. Also, the digital multifunction peripheral receives print data from the external devices via the LAN.

The image data read out by the scanner unit 109 is transferred to a scanner image processing unit 107 via a scanner I/F 108. The processed image data is transferred to the DRAM 103 and stored therein.

The image data is subjected to image processing, as required, stored in the DRAM 103 again, and transferred to the hard disk controller 113 from the DRAM 103. The image data is transferred to a printer image processing unit 110. The image data processed in the printer image processing unit 110 is further transferred to a printer unit 112 via a printer I/F 111.

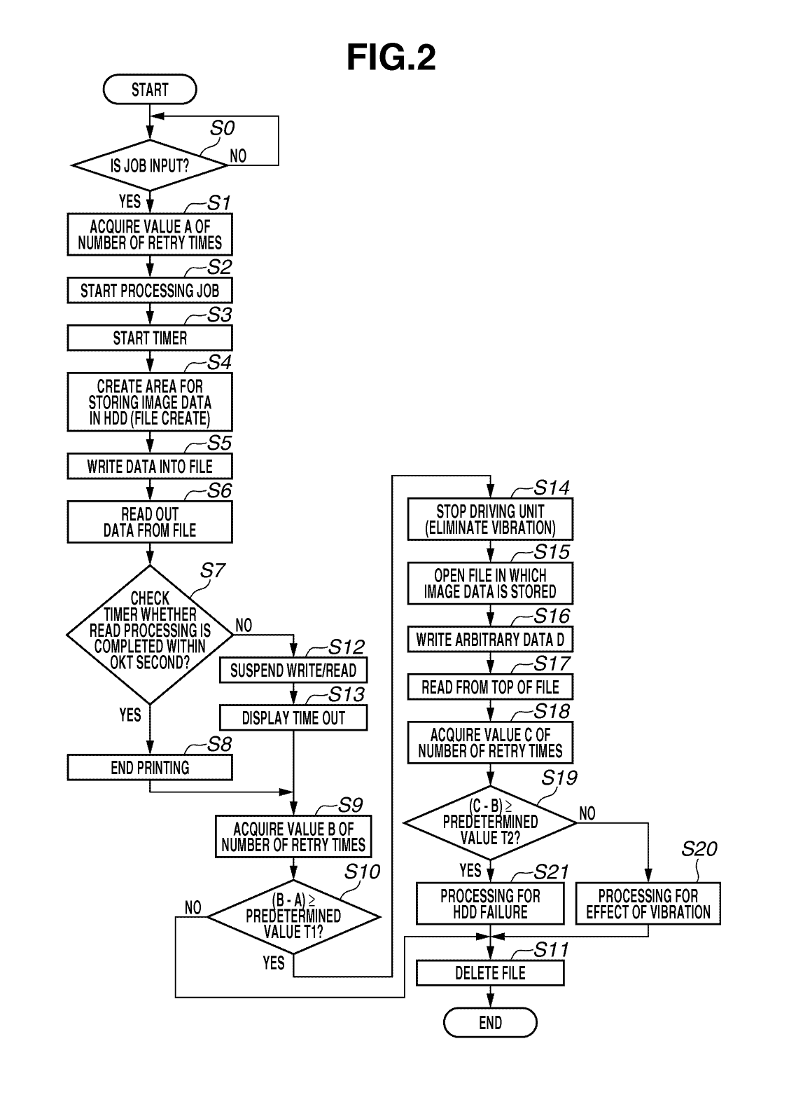

FIG. 2 is a flow chart illustrating a control performed in the image forming apparatus 200 according to the present exemplary embodiment. More specifically, FIG. 2 illustrates an example of processing for diagnosing the HDD 144 based on a difference between the number of retry times occurred during a transfer of the image forming data to the HDD 114 in execution of the image forming processing and the number of retry times occurring in a suspended state of the driving unit.

A value of the number of retry times is the number how many times the CPU 105 retries the writing of the data in response to an abnormal end of the data transfer. Each step is realized by the CPU 105 loading a control program stored in the ROM 106 to the DRAM 103 to execute it thereon. In the present exemplary embodiment, a case where the image forming apparatus includes a single HDD 114 is exemplified. However, the image forming apparatus may include a plurality of HDDs 114.

In step S0, the CPU 105 determines whether the job is input. Examples of the job type include a copying job in which an image read out by the scanner unit 109 is printed by the printer unit 112, and a print job in which an image received from an external device via the LAN is printed. The copying job is exemplified here; however, the following operations are also applicable when the print job is executed.

In a case where a job for executing the copying job is input according to job processing conditions set by a user via the operation unit 101 (YES in step S0), the CPU 105 advances the processing to step S1.

In step S1, the CPU 105 recognizes a value of the number of retry times before starting the job, and stores a value A, i.e., the recognized number of retry times in the DRAM 103. The value of the number of retry times is stored in the SRAM 104 and the value is incremented by one every time the retry is made.

In step S2, the CPU 105 starts processing the input job. The CPU 105 causes a driving unit of the printer unit 112 to drive so as to start preparing for printing. In step S3, the CPU 105 causes a timer to start a timer check processing, and advances the processing to step S4.

The CPU 105 creates a file in an HDD area in order to store the image data read out via the scanner unit 109 or the network I/F 115 in the HDD 114. Then, the CPU 105 advances the processing to step S5. In step S5, the CPU 105 writes the image data into the file.

Subsequently, the CPU 105 advances the processing to step S6. In step S6, the CPU 105 reads out the image date from the file created in the HDD area. In step S7, the CPU 105 acquires a timer value checked by the timer (not illustrated) upon completion of the read processing, and calculates a data transfer processing time required for the write processing and the read processing of the data. The CPU 105 subsequently determines whether the calculated data transfer processing time is within a predetermined time period.

In a case where the CPU 105 determines that the data transfer processing time is within the predetermined time period (YES in step S7), the CPU 105 advances the processing to step S8. In step S8, the CPU 105 normally ends the print processing of the data of the started job performed by the printer unit 112. Then, the CPU 105 advances the processing to step S9.

On the other hand, in a case where the CPU 105 determines that the data transfer processing is not completed within the allotted time (i.e., threshold) frame (NO in step S7), the CPU 105 advances the processing to step S12. In step S12, the CPU 105 suspends the writing and the reading of the data. In step S13, the CPU 105 displays a time-out message on the operation unit 101 and advances the processing to step S9.

In step 9, the CPU 105 stores on the DRAM 103 a value B (the number of retry times) measured in the data transfer processing to the HDD 114 when the CPU 105 executes steps S5 and S6. In step S10, the CPU 105 calculates a difference between the value A (the number of retry times) and the value B (the number of retry times) measured in step S1.

The CPU 105 compares the difference value (B−A) with the predetermined value (i.e., threshold) T1 stored in the HDD 114 to determine whether the difference value (B−A) is equal to or larger than the predetermined value T1. In other words, the CPU 105 determines whether the number of retry times occurred during the writing processing and the reading processing of the data is equal to or more than a predetermined times.

In a case where the CPU 105 determines that the difference value (B−A) is smaller than the predetermined value T1 (NO in step S10), the CPU 105 determines that the decrease of the data transfer rate has not occurred and advances the processing to step S11. In step S11, the CPU 105 deletes the file written in the HDD 114 in step S5 and normally ends the print processing.

On the other hand, in a case where the CPU 105 determines that the difference value (B−A) is equal to or larger than the predetermined value T1 (YES in step S10), the CPU 105 determines that the decrease of the data transfer rate occurs. Then, the CPU 105 advances the processing to step S14, and the CPU 105 suspends the driving of the driving unit that is the vibration source of the image forming apparatus to eliminate the vibration that exerts an adverse effect to the HDD 114. The predetermined value T1 may be stored in the ROM 106.

In step S15, the CPU 105 opens a file of the image data stored in the HDD 114. Then, the CPU 105 advances the processing to step S16, and the CPU 105 writes arbitrary data D into the file with respect to the storage area identical to the storage area of the HDD 114 used in steps S5 and S6. At the time, the arbitrary data D desirably is “0” data of a size identical to the image data.

Instep S17, the CPU 105 reads out the image data from a top of the file stored in the storage area of the HDD 114. After the CPU 105 ends the reading of the image data, the CPU 105 advances the processing to step S18, and the CPU 105 stores a measurement value of the retry value that occurs during the data transfer processing to the HDD 114 in the DRAM 103 as a value C (the number of retry times).

In step S19, the CPU 105 calculates a difference between the value C (the number of retry times) and the value B (the number of retry times) measured and stored in the DRAM 103. Then, the CPU 105 compares the resultant value with the predetermined value T2 stored in the HDD 114, and determines whether the difference value (C−B) is equal to or larger than the predetermined value T2. In other words, the CPU 105 can determine the factor why the decrease of the data transfer rate to the HDD 114 occurs based on the determination result in S19.

In a case where the CPU 105 determines that the difference value (C−B) is smaller than the predetermined value T2 (NO in step S19), the CPU 105 determines that the decrease of the transfer rate occurs due to the adverse effect of the vibration generated by the vibration source. Then, the CPU 105 advances the processing to step S20.

In step S20, the CPU 105 issues a message to notify that the decrease of the transfer rate occurs due to the vibration generated by the vibration source to the operation unit 101. At the time, the CPU 105 may request the user to call a service engineer.

The CPU 105 advances the processing to step S11, and the CPU 105 deletes the file stored in the storage area of the HDD 114 in step S16, and then ends the processing. In step S20, the CPU 105 displays a request to the user via a screen displayable on the operation unit 101. The contents of the message or the like to be displayed thereon are not limited to any specific contents, and the screen can be cleared off by using, for example, a button displayed on the currently displayed screen.

On the other hand, in a case where the CPU 105 determines that the difference vale (C−B) is larger than the predetermined value T2 (YES in step S19), the CPU 105 determines that the decrease of the data transfer rate with respect to the HDD 114 occurs due to the factor other than the vibration generated by the vibration source. Then, the CPU 105 advances the processing to step S21. The factor other than the factor due to the vibration generated by the vibration source is a malfunction of the HDD 114 of its own.

In step S21, the CPU 105 notifies to the operation unit 101 that an abnormality of the HDD 114 is caused by the factor other than the adverse effect of the vibration (i.e., malfunction of the HDD 114), and prompts the user to make a service call for calling a service engineer.

At the time, the CPU 105 may display a notification for prompting the user to replace the HDD 114 on the operation unit 101. Then, the CPU 105 advances the processing to step S11, and the CPU 105 deletes the file stored in the HDD 114 and ends the present processing.

Accordingly, in a case where the decrease of the data transfer rate to the HDD 114 occurs in a state where the job is actually being processed, the CPU 105 writes data into the storage area similar to the storage area of the HDD 114t used in transferring the data, and can specify the factor why the decrease of the data transfer rate has occurred.

In other words, the CPU 105 can securely specify whether the vibration generated by the vibration source is the factor that causes the decrease of the data transfer rate, through the execution of the data transfer processing using the storage area of the HDD 114 to be used in the actual job processing.

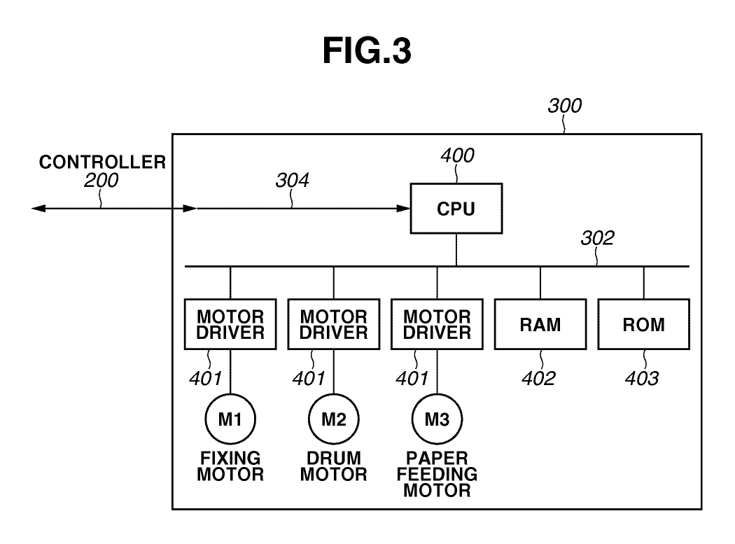

FIG. 3 is a block diagram illustrating a configuration of the driving unit (i.e., motor control unit) for driving the rotation system of the image forming apparatus illustrated in FIG. 1. FIG. 3 an example in which the controller unit 300 controls driving of a plurality of motors of the rotation system (i.e., vibration sources).

In FIG. 3, the controller unit 300 is connected to the system controller 200 via a line 304. A CPU 400 collectively controls accesses of the devices connected to the system bus 302 based on a program stored in a ROM 403. A RAM 402 is used as a system work memory.

Motor drivers 401 control a fixing motor M1, a drum motor M2, and a paper feeding motor M3, respectively. The fixing motor M1 functions as a motor for transferring a rotatably driving force to a fixing roller accommodated in a fixing unit (not illustrated). The drum motor M2 functions as a motor for transferring a rotatably driving force to, for example, a photosensitive drum (not illustrated).

The paper feeding motor M3 functions as a motor for transferring a rotatably driving force for driving a pickup roller and a conveyance roller in order to pick up and convey paper sheets stacked in a paper stacker such as a sheet cassette.

A clutch (not illustrated) controls the rotatably driving force of each roller. The CPU 105 drives the plurality of vibration sources to perform the copying processing, the print processing, and the like. At the time, the HDD 114 suffers no small adverse effect of the vibration from the vibration sources.

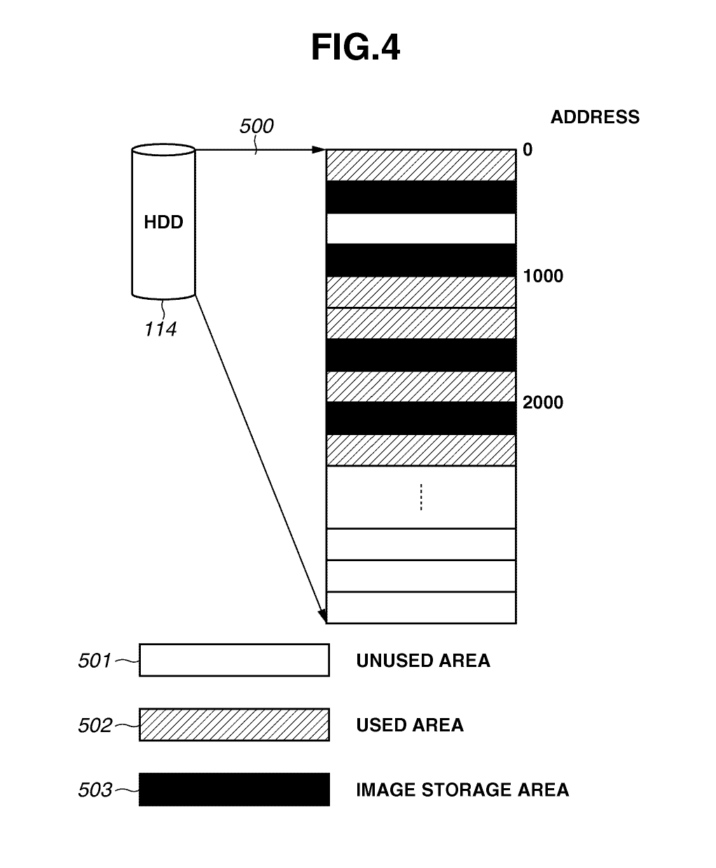

A status of an allocated address of the HDD 114 is described below. FIG. 4 is a memory map illustrating an example of an address to be allotted to the HDD 114 illustrated in FIG. 1.

In FIG. 4, an available storage area 500 of the HDD 114 includes an unused storage area 501, a used storage area 502, and an image storage area 503. A present state of the available storage area 500 indicates a status of a created file (i.e., File Create) created in the HDD area, i.e., file storing the image data.

When the CPU 105 opens the file stored in the HDD 114 (i.e., File Open), the CPU 105 can execute the Write/Read with respect to the file from the address of the available storage area 500 (i.e., head address), i.e., from a head of the file.

In view of the above, a data amount of a size physically identical to a data amount of the corresponding area of the HDD 114 can be written and/or read in the available storage area 500.

In the above described exemplary embodiment, a case where the CPU 105 determines whether the decrease of the data transfer rate occurs by measuring the number of retry times during the data transfer processing is described. However, the CPU 105 may determine whether the decrease of the data transfer rate occurs by measuring a data transfer time to the HDD 114.

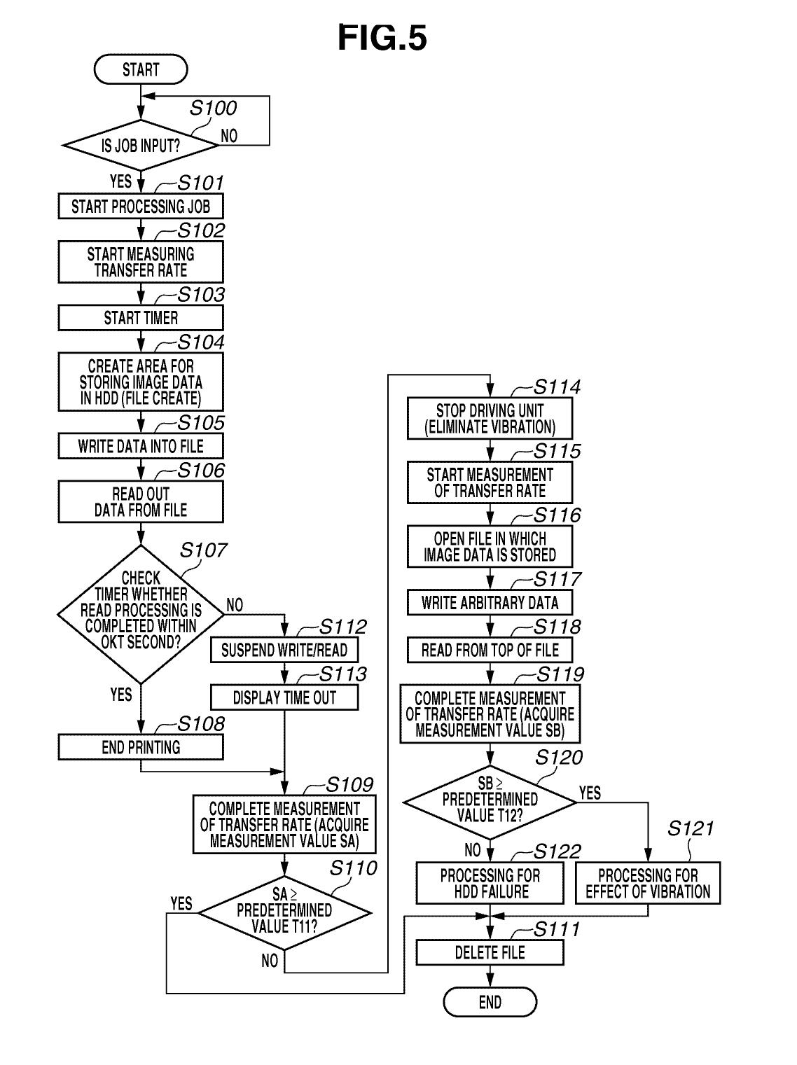

FIG. 5 is a flow chart illustrating a method for controlling the image forming apparatus according to a second exemplary embodiment. FIG. 5 illustrates an example processing for making a malfunction diagnosis of the HDD 114. Each step is realized by the CPU 105 loading a control program stored in the ROM 106 to the DRAM 103 and executing the program.

In step S100, in a case where a job is input according to the job processing conditions set by the user with the operation unit 101 (YES in step S100), in step S101, the CPU 105 causes the operation unit 101 to start performing processing of the job required by the user. In step S102, the CPU 105 starts processing for measuring the transfer rate.

In step S103, the CPU 105, subsequently, starts a timer (not illustrated) for executing a timer check. Then, the CPU 105 advances the processing to step S104. In step S104, the CPU 105 creates a file in the unused storage area 501 of the HDD area in order to store the image data read out via the scanner unit 109 or the network I/F 115 in the HDD 114. The CPU 105 advances the processing to step S105. In step S105 the CPU 105 writes the image data into the file.

The CPU 105 advances the processing to step S106. In step S106, the CPU 105 reads out data from the file created in the unused storage area 501 of the HDD area of the HDD 114. Then, the CPU 105 advances the processing to step S107. In step S107, the CPU 105 determines whether a time at which the read processing of the data is ended is past the predetermined time OKT by comparing it with the value timed by the timer started in step S103.

In a case where the CPU 105 determines that the measured data processing time is within the designated time OKT (YES in step S107), the CPU 105 advances the processing to step S108. In step S108, the CPU 105 ends the print processing performed by the printer unit 112 normally. The value OKT may be preliminary stored in, for example, the ROM 106.

On the other hand, in step S107, the CPU 105 determines whether the time period from the start of writing data into the file of the HDD 114 to the end of reading the data therefrom exceeds the predetermined time OKT. In a case where the CPU 105 determines that the time period exceeds the predetermined time OKT (NO in step S107), the CPU 105 advances the processing to step S102.

In step S102, the CPU 105 suspends writing/reading the data into/from the file of the storage area of the HDD 114. In step S103, the CPU 105 displays the time out message on the operation unit 101.

In step S109, the CPU 105 holds on the DRAM 103 the data transfer rate calculated based on the measured time and data transfer amount as a value SA of the data transfer rate. In step S110, the CPU 105 compares the measured value SA of the data transfer rate with the predetermined value T11 stored in the ROM 106.

More specifically, the CPU 105 determines whether the value SA of the data transfer rate is equal to or larger than the predetermined value T11 held in the ROM 106. In a case where the CPU 105 determines that the measured value SA of the data transfer rate is equal to or larger than T11 (YES in step S110), the CPU 105 determines that the decrease of the data transfer rate has not occurred, and advances the processing to step S111.

In step S111, the CPU 105 deletes the file written in the storage area of the HDD 114 in step S105 therefrom, and ends the present processing.

On the other hand, in a case where the CPU 105 determines that the measured value SA of the data transfer rate is smaller than the predetermined value T11 (NO in step S110), the CPU 105 determines that the decrease of the data transfer rate occurs, and advances the processing to step S114.

In step S114, the CPU 105 temporarily suspends driving of each of the motors M1 through M3 as the vibration sources of the image forming apparatus to reduce the vibration generated during the data transfer processing. Alternatively, the CPU 105 may suspend any one of the motors of which vibration force is the highest.

In step S115, the CPU 105 starts processing for measuring the data transfer rate to the HDD 114. In step S116, the CPU 105 opens the file of the image data stored in the storage area of the HDD 114. In step S117, the CPU 105 writes arbitrary data into the file of the HDD 114. The arbitrary data at the time has a size similar to that of the image data, i.e., desirably the “0” data.

In step S118, the CPU 105 starts processing for reading out the image data from a top of the file held in the storage area of the HDD 114. After the end of the read processing, the CPU 105 advances the processing to step S119. In step S119, the CPU 105 holds the data transfer rate measured until the end of the read processing in the DRAM 103 as the value SB.

In step S120, the CPU 105 compares the measured value SB indicating the data transfer rate with a predetermined value T12 stored in the ROM 106 to determine whether the measured value SB indicating the data transfer rate is equal to or more than the predetermined value T12. In other words, the CPU 105 can determine the factor why the decrease of the data transfer rate of the HDD 114 occurs based on the determination result of step S120.

In a case where the CPU 105 determines that the value SB indicating the data transfer rate is equal to or more than the predetermined value T12 (YES in step S120), the CPU 105 determines that the decrease of the data transfer rate occurs due to the vibration generated by the vibrating member, and advances the processing to step S121.

In step S121, the CPU 105 executes processing for issuing a message to notify that the abnormality of the HDD 114 occurs due to the vibration generated by the vibrating member, to the operation unit 101 via the user interface. The processing includes making a service call for calling a service engineer. Then, the CPU 105 advances the processing to step S111. In step S111, the CPU 105 deletes the file written into the storage area of the HDD 114, and ends the present processing.

On the other hand, in a case where the CPU 105 determines that the value SB indicating the data transfer rate is smaller than the predetermined value T12 (NO in step S120), the CPU 105 determines that the decrease of the data transfer rate occurs due to a factor other than the factor caused by the vibration generated by the vibrating member (i.e., malfunction of the HDD 114). Then, the CPU 105 advances the processing to step S122.

In step S122, the CPU 105 determines that the decrease of the data transfer rate of the HDD 114 occurs due to a factor other than the factor caused by the vibration of the driving unit of the image forming apparatus (i.e., malfunction of the HDD 114). The CPU 105 displays a message indicating that the decrease of the data transfer rate occurs due to the factor other than the factor caused by the vibration of the driving unit of the image forming apparatus (i.e., malfunction of the HDD 144) on the operation unit 101 via the user interface.

The above processing includes making a service call for calling a service engineer. At the time, the CPU 105 may display a notification for prompting the user to replace the HDD 114 on the operation unit 101. Then, the CPU 105 advances the processing to step S111. In step S111, the CPU 105 deletes the file written in the storage area of the HDD 114, and ends the present processing.

Accordingly, in a case where the decrease of the data transfer rate to the HDD 114 occurs in a state that the CPU 105 actually is processing the job, the CPU 105 performs processing for writing data in the storage area similar to the storage area of the HDD 114 to be used during the data transfer, and can specify the factor why the decrease occurs.

In other words, a secure specification can be performed whether the decrease of the data transfer rate of the HDD 114 occurs due to the vibration generated by the vibration source, through the execution of the data transfer processing using the storage area of the HDD 114 to be used in the actual job processing.

In the above described exemplary embodiments, cases where the predetermined values T1, T2, T11, and T12 are stored in the ROM as fixed values, are exemplified. However, the present invention is not limited thereto, and the predetermined values T1, T2, T11, and T12 may be stored in the SRAM 104 to be changeable by a service engineer via the operation unit 101. Further, the values of T1 and T2 and the values of T11 and T12 may be identical to each other, respectively.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-095348 filed Apr. 21, 2011, which is hereby incorporated by reference herein in its entirety.

What is claimed is:

1. An image forming apparatus for performing image forming processing by driving a driving member, comprising:
a storing unit configured to store data;
a measuring unit configured to measure a number of retry times occurring in transferring predetermined data to the storing unit while driving the driving member;
a specifying unit configured to specify a number of retry times occurring in transferring the predetermine data to the storing unit while suspending an operation of the driving member; and
a notification unit configured to notify a factor why a decrease of a data transfer rate to the storing unit occurs according to the number of retry times measured by the measuring unit and the number of retry times specified by the specifying unit.

2. The image forming apparatus according to claim 1, further comprising:
a determining unit configured to determine whether the number of retry times measured by the measuring unit is equal to or more than a predetermined number of times,
wherein, when the determining unit determines that the number of retry times measured by the measuring unit is equal to or larger than the predetermined number of times, the specifying unit specifies the number of retry times occurring in transferring the predetermined data to the storing unit while the operation of the driving member is suspended.

3. The image forming apparatus according to claim 1, wherein, when a difference between the number of retry times stored in the storing unit and the number of retry times specified by the specifying unit is equal to or larger than a predetermined number of times, the notification unit notifies that the decrease of the data transfer rate to the storing unit occurs due to an adverse effect of a vibration generated by the driving member.

4. The image forming apparatus according to claim 1, wherein the notification unit issues notification for prompting a user to replace the storing unit when the difference between the number of retry times stored in the storing unit and the number of retry times specified by the specifying unit is smaller than the predetermined number of times.

5. The image forming apparatus according to claim 1, wherein the driving member includes a driving member for driving a printer unit that executes the image forming processing.

6. An image forming apparatus for performing image forming processing by driving a driving member, comprising:
a storing unit configured to store data;
a measuring unit configured to measure a transfer rate in transferring predetermined data to the storing unit while driving the driving member;
a specifying unit configured to specify a transfer rate in transferring the predetermined data to the storing unit while an operation of the driving member is suspended; and
a notification unit configured to notify a factor why a decrease of the data transfer rate to the storing unit occurs according to the transfer rate measured by the measuring unit and the transfer rate specified by the specifying unit.

7. A control method for controlling an image forming apparatus that performs image forming processing by driving a driving member, the method comprising:
storing data in a storing unit;
measuring a transfer rate in transferring predetermined data to the storing unit while driving the driving member;
specifying a transfer rate in transferring the predetermined data to the storing unit while suspending an operation of the driving member; and
notifying a factor why a decrease of the data transfer rate to the storing unit occurs according to the measured transfer rate and the specified transfer rate.
